(19) United States
(12) Patent Application Publication
(10) Pub. No.: US 2010/0082395 A1
(43) Pub. Date: Apr. 1, 2010

(54) Systems and methods for analyzing a portfolio of intellectual property assets

(76) Inventor: Anthony Bernard De Andrade, Kihei, HI (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/285,057

(22) Filed: Sep. 29, 2008

(51) Int. Cl. G06Q 50/00; G06Q 10/00; G06F 17/30

(52) U.S. Cl. 705/8; 705/30; 705/7; 705/10

(57) ABSTRACT

Methods and systems consistent with embodiments of the present invention provide flexible analysis of a portfolio of intellectual property (IP) assets. IP assets may include, for example, granted patents, registered trademarks, copyrights, patent applications, trademark applications, etc. Analysis consistent with the present invention may include, for example, forecasting worldwide cost estimates for a portfolio of IP assets. An IP portfolio may consist of one or more families of assets. For example, a patent family may include granted patents and related patent applications filed in countries and regional patent offices around the world. Furthermore, IP assets may be categorized into groups. For example, IP assets may be grouped by technology group, company division, patent manager, etc. In certain embodiments, an IP asset may be part of several groups.

### FIELD OF THE INVENTION

The present invention generally relates to analyzing intellectual property assets. More particularly, the invention relates to systems and methods for predicting and analyzing costs associated with IP assets.

### BACKGROUND OF THE INVENTION

Owners of intellectual property (IP) assets such as patents, copyrights, and trademarks, and particularly owners of sizable IP portfolios, have a substantial interest in knowing how much their IP protection costs. Using current systems, IP practitioners often must prepare fee estimates for their clients by manually collecting, calculating, and organizing relevant information about the IP at issue. This can be a daunting task for even a single patent or trademark application, much less an entire portfolio.

IP practitioners typically manage patent portfolios on a computer via a docketing system. The primary purpose of a docketing system is to keep track of due dates associated with IP assets in various countries, with limited cost tracking functionality. IP portfolios can vary considerably in size, from a few IP assets to thousands. Analyzing and predicting costs associated with the assets in an IP portfolio becomes increasingly difficult as the size of the portfolio increases. Such massive amounts of data are not easily accessed, displayed, or understood. Data entry and maintenance become unwieldy and data analysis complicated

### SUMMARY OF THE DISCLOSURE

Methods and systems consistent with the present invention provide robust and flexible analysis of IP portfolios, including streamlined data gathering and organization; flexible grouping and identification of IP assets, families, and portfolios; meaningful cost analysis and forecasting; versatile reporting abilities; and rapid calculation methods.

In certain embodiments, methods and systems are provided for managing costs for a portfolio of intellectual property assets by receiving data about a plurality of intellectual property assets in the portfolio and providing fee rules for countries in the plurality of intellectual property assets, each fee rule including at least one of a country code, cost type, stage code, application information item, and currency code. The fee rules are applied to determine cost data for the plurality of intellectual property assets and a user is enabled to select a subset of the plurality of intellectual property assets. An analysis selection is received from the user specifying an analysis based on all or part of the plurality of intellectual property assets, and the determined cost data for the subset of intellectual property assets is presented to the user according to the analysis selection.

In other embodiments, methods and systems manage costs for a portfolio of intellectual property assets by receiving data about the portfolio of intellectual property assets, the data including a family designation for each intellectual property asset in the portfolio. Fee rules corresponding to countries in the plurality of intellectual property assets are identified, each fee rule including at least one of a country code, cost type, stage code, application information item, and currency code. Prosecution stage timing rules corresponding to the countries in the plurality of intellectual property assets are identified, each prosecution stage timing rule including at least one of a country code, stage code, and a time to reach the stage. The fee rules and prosecution stage timing rules are applied to determine cost data and prosecution stage timing dates for each asset in the plurality of intellectual property assets. A user is enabled to select a subset of the plurality of intellectual property assets and to select an analysis, and determined cost data and prosecution stage timing data for the subset of intellectual property assets are presented to the user according to the selected analysis.

Still further, embodiments provide methods and systems for analyzing costs for a patent portfolio including a plurality of patent families by receiving patent data about each patent asset in the plurality of patent families, the patent data including a country code and asset attributes. Fee rules for the patent portfolio are identified, each fee rule including a country code, a stage code, and a fee category. For each patent asset in the patent portfolio, a date when the asset will enter a prosecution stage is predicted based on the corresponding asset attributes, the prosecution stage being one of filing, examination, grant, and maintenance; fee rules are selected corresponding to the country code of the patent asset and the stage code corresponding to the prosecution stage; and the selected fee rules are applied to the patent data about the patent asset to determine stage costs for the patent asset. The stage costs for the plurality of patent assets in the patent portfolio are collected to determine overall stage costs for each prosecution stage, and the overall stage costs for the patent portfolio are presented.

Additional aspects of the present invention will be set forth in part in the description which follows, and in part will be clear from the description, or may be learned by practice of the invention. The foregoing general description and the following detailed description are exemplary and explanatory only and are not restrictive of the invention, as claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary block diagram of a system for managing IP rights consistent with embodiments of the present invention;

FIG. 2 illustrates a flowchart of an exemplary process for analyzing costs for patents and patent applications, consistent with embodiments of the present invention;

FIG. 3 illustrates an exemplary process for receiving data about patent families, consistent with embodiments of the present invention;

FIG. 3A illustrates an exemplary user screen for importing data by batch, consistent with embodiments of the present invention;

FIG. 3B illustrates another exemplary user screen for importing data by batch, consistent with embodiments of the present invention;

FIG. 3C illustrates an exemplary user screen for manually adding patent data, consistent with embodiments of the present invention;

FIG. 4 illustrates an exemplary process for producing cost results, consistent with embodiments of the present invention;

FIG. 5 illustrates an exemplary process for storing cost results by patent family, consistent with embodiments of the present invention;

FIG. 6 illustrates an exemplary process for grouping patent family data into groups, consistent with embodiments of the present invention;

FIG. 7 illustrates an exemplary process for producing reports, consistent with embodiments of the present invention;

FIG. 7A illustrates an exemplary user screen for subsequent reporting, consistent with embodiments of the present invention;

FIG. 7B illustrates an exemplary detailed report, consistent with embodiments of the present invention;

FIG. 7C illustrates an exemplary stage view report, consistent with embodiments of the present invention;

FIG. 7D illustrates an exemplary date view report, consistent with embodiments of the present invention;

FIG. 7E illustrates an exemplary stage view spreadsheet, consistent with embodiments of the present invention;

FIG. 7F illustrates an exemplary category view spreadsheet, consistent with embodiments of the present invention;

FIG. 7G illustrates an exemplary totals view spreadsheet, consistent with embodiments of the present invention;

FIG. 8 illustrates an exemplary process for performing analyses, consistent with embodiments of the present invention;

FIG. 8A illustrates an exemplary user screen for portfolio cost analysis, consistent with embodiments of the present invention;

FIG. 8B illustrates another exemplary user screen for portfolio cost analysis, consistent with embodiments of the present invention;

FIG. 8C illustrates another exemplary user screen for portfolio cost analysis, consistent with embodiments of the present invention; and

FIGS. 8D-8L depict sample analysis reports for a patent portfolio, consistent with embodiments of the present invention.

### DETAILED DESCRIPTION

The following detailed description refers to the accompanying drawings. Wherever possible, the same reference numbers will be used throughout the drawings to refer to the same or like parts. While several exemplary embodiments and features of the invention are described herein, modifications, adaptations and other implementations are possible, without departing from the spirit and scope of the invention. For example, substitutions, deletions, additions, or modifications may be made to the components illustrated in the drawings, and the exemplary methods described herein may be modified by substituting, deleting, reordering, or adding steps to the disclosed methods. Accordingly, the following detailed description does not limit the invention. Instead, the proper scope of the invention is defined by the appended claims.

Methods and systems consistent with embodiments of the present invention provide flexible analysis of a portfolio of intellectual property (IP) assets. IP assets may include, for example, granted patents, registered trademarks, copyrights, patent applications, trademark applications, etc. Analysis consistent with the present invention may include, for example, forecasting worldwide cost estimates for a portfolio of IP assets.

An IP portfolio may consist of one or more families of assets. For example, a patent family may include granted patents and related patent applications. In one example, a patent family may include an original priority patent and other patent applications and/or patents related to the original patent, such as continuing applications, divisional application, and/or applications filed in other countries. Foreign patent applications may be filed directly, through the Patent Cooperation Treaty (“PCT”) process, through a regional patent office such as the European Patent Office (“EPO”), etc. A patent family may include patents and applications in any number of countries. A family of registered trademarks and pending trademark applications may be similarly organized.

One or more IP families may form a portfolio. For example, a patent portfolio may include several patent families related to a certain business unit. In another example, an IP portfolio may include different types of IP assets, such as trademarks, design patents, and utility patents related to a product. Furthermore, IP assets may be categorized into groups according to the IP owner's business organization. For example, IP assets may be grouped by technology group, company division, patent manager, etc. In certain embodiments, an IP asset may be part of several groups.

Embodiments of the present invention provide methods and systems for predicting and analyzing data, such as cost data or prosecution stage event data for a portfolio of IP assets. For example, certain embodiments of the present invention may analyze costs for a portfolio of patents and patent applications for each stage of each country in each patent family based on the attributes of the patents and patents applications in the portfolio. In another example, a portfolio analysis may be performed to predict future costs for all of the trademark applications in a selected group or combination of groups. Cost totals may be provided, for example, by year, by quarter, or by month, for any given range of dates. In another example, the analysis may determine prosecution event dates and/or costs that will occur in each year for each stage in each country for each asset in a family.

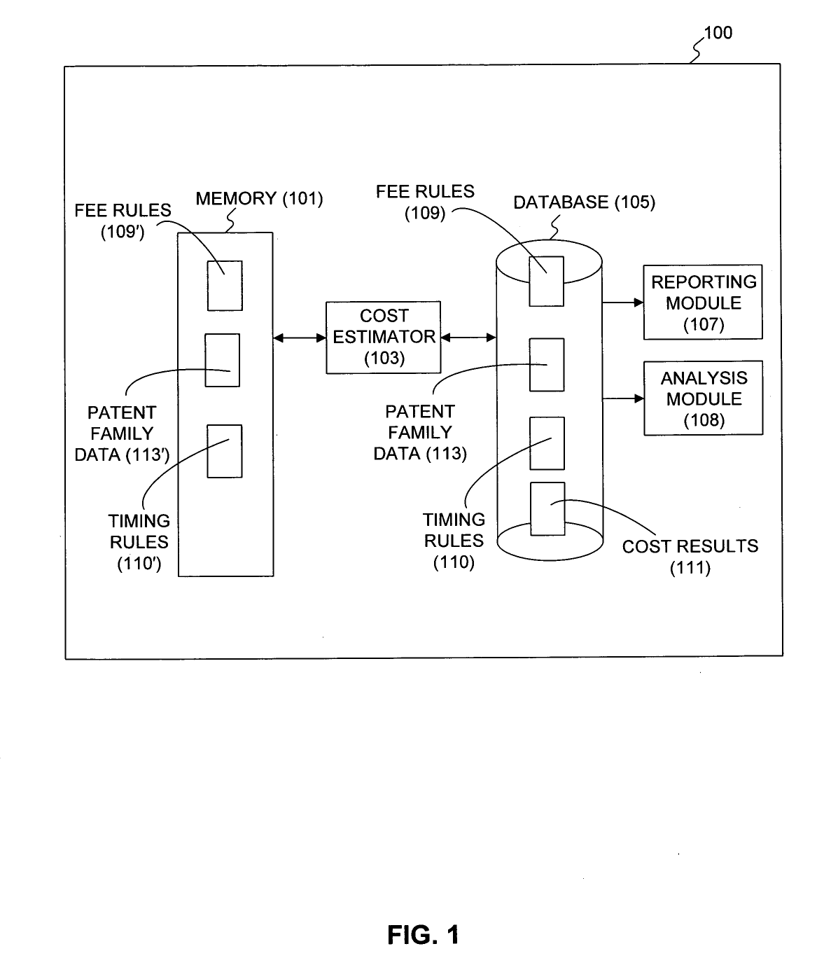

FIG. 1 illustrates an exemplary block diagram of a system for managing IP costs consistent with embodiments of the present invention. It depicts a portfolio cost analyzer (“PCA”) 100, including memory 101, cost estimator 103, database 105, reporting module 107, and analysis module 108. Database 105 may store fee rules 109, timing rules 110, cost results 111, and patent family data 113. PCA 100 may use cost estimator 103 to analyze costs related to an IP asset, such as a patent or trademark application or issued patent, by processing fee rules 109′, patent family data 113′, and/or timing rules 110′ stored in memory 101 to produce cost results 111. Cost results 111 may be stored in a database 105 for use by, for example, reporting module 107 and/or analysis module 108. Reporting module 107 may be used by PCA 100 to report cost results 111, e.g., by displaying them to a user of PCA 100. Cost results 111 may also be used, for example, to perform updated analysis using analysis module 108. For example, if a currency exchange rate changes, the change may be applied directly to stored cost results 111, avoiding the need to reprocess cost data for an entire patent portfolio or family. In certain embodiments, analysis module 108 may be used by PCA 100 to produce analytic reports across one or more IP families in the portfolio.

PCA 100 may use memory 101 to store and process information such as fee rules 109′, timing rules 110′, and patent family data 113′. In certain embodiments, patent family data 113, stored in database 105, may include data for multiple patent families and patent family data 113′, stored in memory 101, may include data for a single patent family read into memory 101 from database 105. Patent family data 113′ may include data about patents and patent applications in a patent family, such as application number, country, title, filing date, number of pages, number of claims, number of drawings, assignee, etc. Patent family data 113′ may also include data about relationships between patents and patent applications, such as priority data, continuity data, patent family links, patent portfolio links, group(s), etc.

In certain embodiments, fee rules 109, stored in database 105, may include fee rules for a plurality of countries. As costs change, corresponding fee rules 109 may be updated accordingly or new fee rules 109 may be implemented. Costs may change, for example, when a patent office raises its fees, when attorneys change, when exchange rates fluctuate, when claims are added to or cancelled from an application, etc.

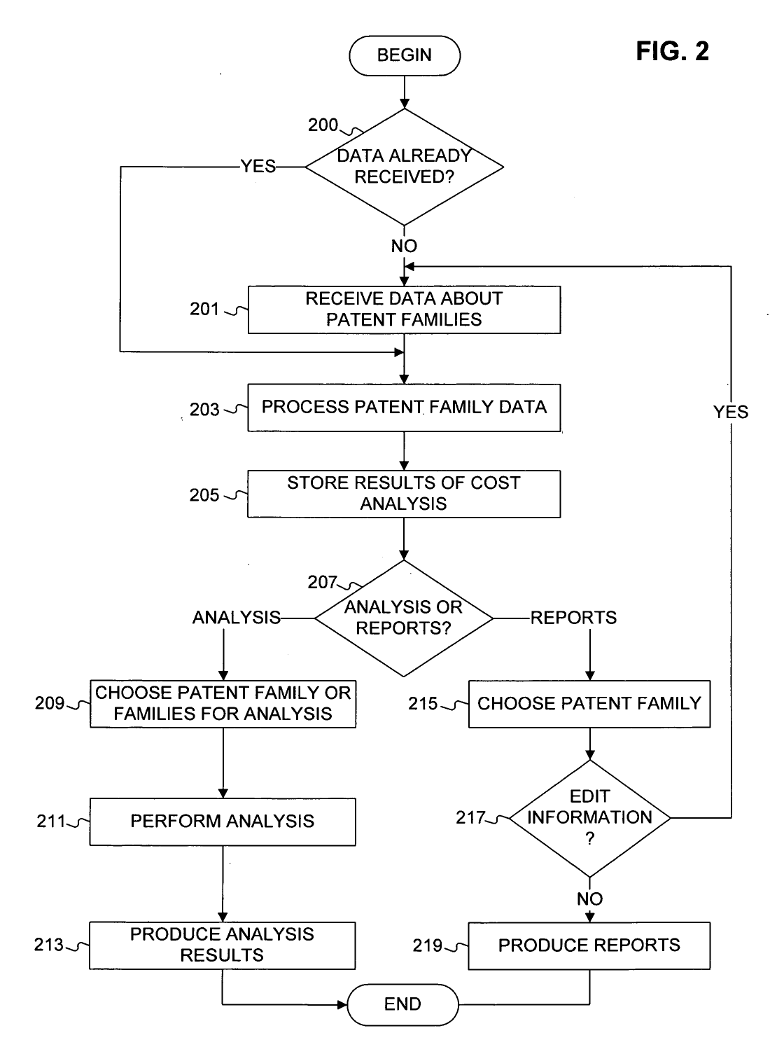

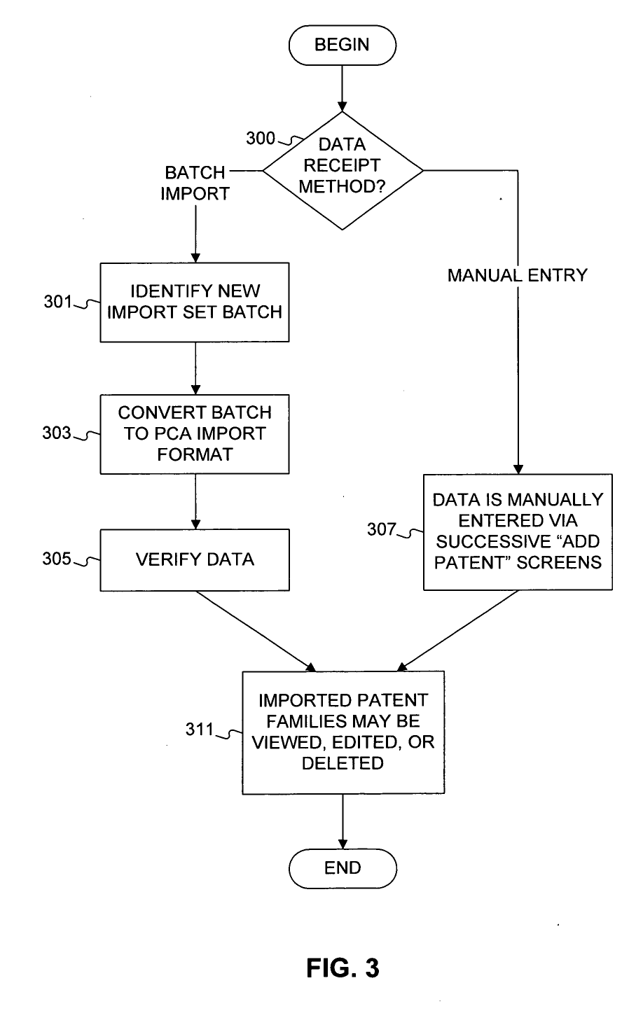

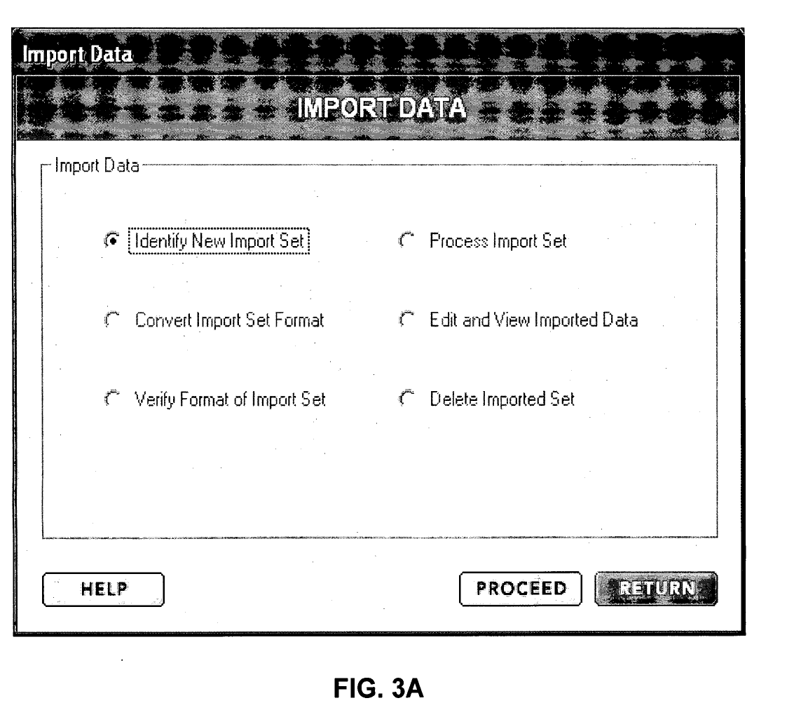

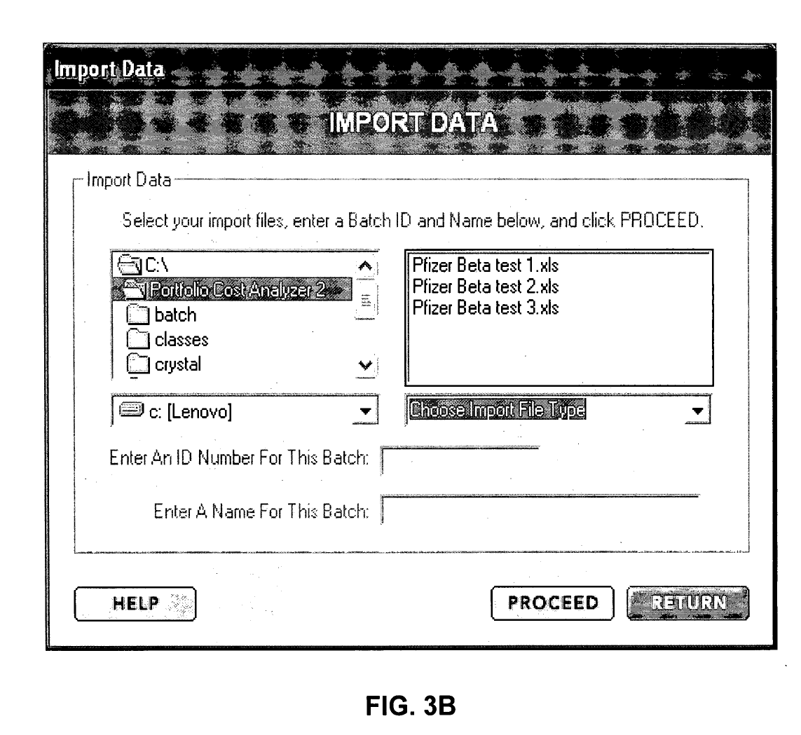

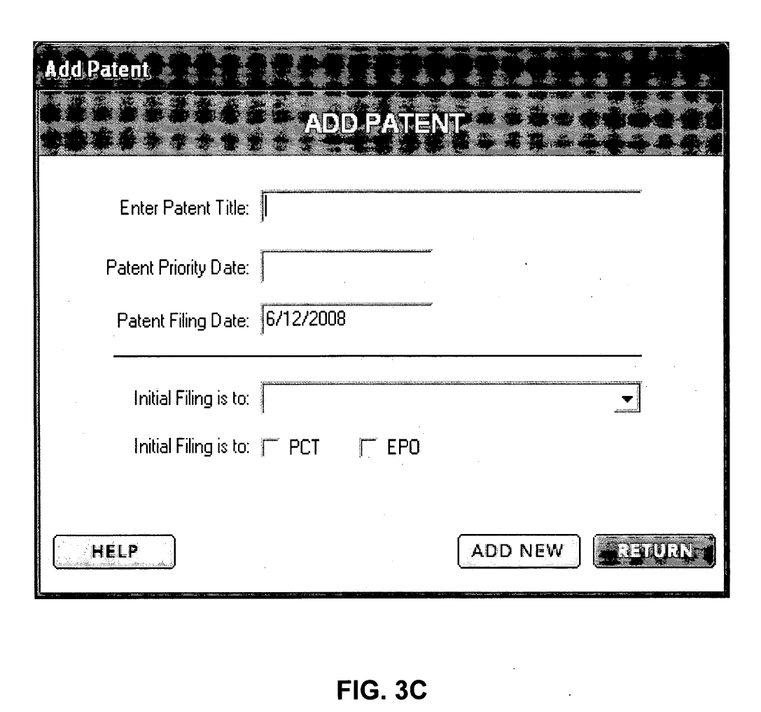

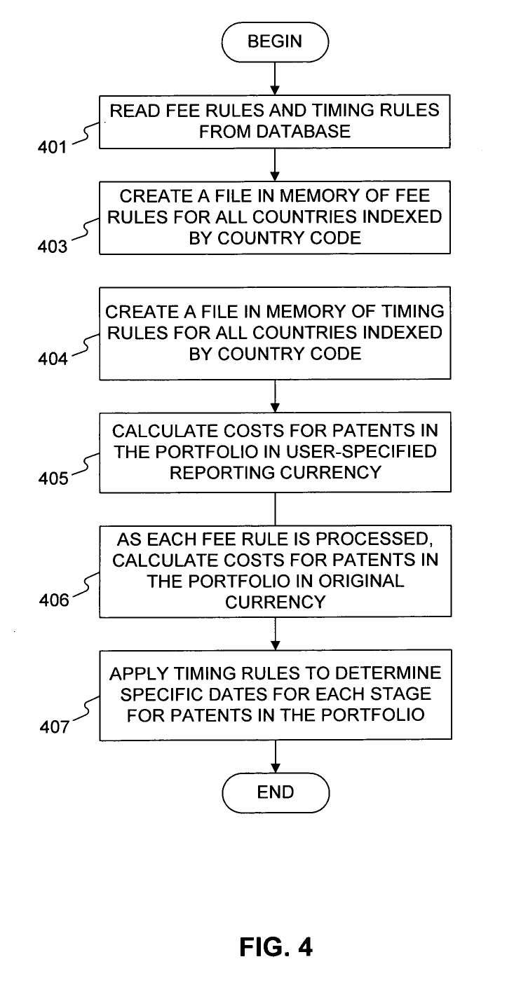

FIG. 2 illustrates a flowchart of an exemplary process for analyzing costs for patents and patent applications, consistent with embodiments of the present invention. PCA 100 begins its processing by receiving patent family data from a user, if it has not previously been received (step 200). If patent family data was not previously received (step 200, NO), then PCA 100 receives patent family data 113 (step 201). Patent family data may include, for example, a patent's country of origin; the stage of prosecution or issuance of a patent; application information, such as the number of claims or pages in an application; etc. Exemplary methods for receiving patent family data 113 are described in more detail with respect to FIGS. 3, 3A, 3B, and 3C. PCA 100 may then process patent family data 113, e.g., to determine cost results 111 (step 203). For example, cost estimator 103 may apply fee rules 109 and/or timing rules 110 to patent family data 113′ for a single patent family to determine cost results 111 for the patent family, as explained in more detail below in FIG. 4. Cost results 111 may be stored, for example, in memory 101 or database 105 (step 205).

PCA 100 may receive a request from a user to produce reports or to perform analysis (step 207). In certain embodiments, “Reports” are produced for a single patent family while “Analysis” is conducted across one or more patent families. If the user requests reports, then PCA 100 may prompt the user to choose a patent family (step 215), for example by displaying a list of possible patent families for the user to choose from. If the user chooses to edit previously-entered information (step 217, YES), then PCA 100 may facilitate the updating of patent family data 113 and then produce the requested report(s) (step 219). For example, the user may update the number of claims in an application based on ongoing prosecution.

If the user requests an analysis, then PCA 100 may prompt the user to select one or more patent families to analyze (step 209), for example by displaying a list of possible patent families for the user to choose from. PCA 100 may then perform analysis of the chosen patent family or families (step 211) and produce the analysis results to the user of PCA 100 (step 213). For example, PCA 100 may analyze cost results 111 to determine and present all of the predicted future costs related to patents related to a technology group.

FIG. 3 illustrates an exemplary process for receiving data about patent families, consistent with embodiments of the present invention. PCA 100 may determine whether data will be received by importing the data from an electronic source or by manual data entry (step 300). If patent family data 113 is to be imported, then a new import set, or batch, may be identified (step 301). The batch may correspond, for example, to a patent family or patent portfolio and may be converted to a PCA import format (step 303). The data to be imported may then be verified (step 305) and uploaded.

FIG. 3A illustrates an exemplary user screen for receiving patent family data 113. Import data options may include identifying a new import set (or “batch”), processing the import set, converting the import set format, editing and viewing imported data, verifying the format of the import set, or deleting the imported data set.

FIG. 3B illustrates an exemplary user screen for identifying the import set (or “batch”), consistent with embodiments of the present invention. For example, importing data may include prompting a user to select import files, enter a batch ID number, and enter a name for the batch. For example, the batch ID and/or name for the batch could correspond to a patent portfolio or group.

If a user of PCA 100 chooses to manually enter the patent family data, PCA may present data entry screens, such as “Add Patent” screens, to facilitate entry of patent family data 113 in a PCA-compatible format (step 307). Once received, patent family data 311 may be displayed, edited, or deleted by users of PCA 100 (step 311). FIG. 3C illustrates an exemplary user screen for manually adding patent data, consistent with embodiments of the present invention. For example, an Add Patent screen may prompt the user to enter a patent title, patent priority date, patent filing date, an initial filing country, initial filing method, etc.

FIG. 4 illustrates an exemplary process for determining cost results 111, consistent with embodiments of the present invention. Fee rules 109 and timing rules 110 may be read from database 105 and indexed (step 401). A fee rule 109 may be based on, for example, a country code denoting the country of origin; cost types for the country, such as official fees, translation fees, and/or associate fees; a stage code denoting the stage of prosecution or issuance; application information items, such as the number of claims or pages in an application; a currency code denoting in what currency the costs are denominated; etc. In certain embodiments, each fee rule 109 determines a cost for one item in the patent process. Such a fee rule may include a formula based on the associated country, the type of cost, the stage of prosecution, application information items such as the number of claims, and the currency to be considered.

The type of cost may include, for example, official patent office fees, attorney charges, local associate charges, translation costs, etc. Official patent office fees may include, for example, standard fees to file, prosecute, and/or maintain a patent application in that country. Attorney charges and local associate fees may include, for example, fees charged by persons involved in filing, prosecuting, and/or maintaining patent applications.

Fee rules 109 may be collected into fee rules 109′, a file stored in memory 101 (step 403). In certain embodiments, fee rules 109′ may include fee rules for all countries and an index may be created recording the beginning and end of each country code's set of fee rules within fee rules 109′. Thus, during cost calculation, when a country is processed, the index stored in memory 101 enables only the fee rules 109′ corresponding to that country to be applied.

Timing rules 110 may be collected into timing rules 110′, a file stored in memory 101 (step 404). In certain embodiments, timing rules 110′ may include timing rules for all countries and an index may be created recording the beginning and end of each country code's set of timing rules within timing rules 110′.

Fee rules 109′ and timing rules 110′ may then be processed to determine cost results 111 (step 405). For example, costs may be calculated for each patent in a single patent family or a portfolio of patent families. In certain embodiments, cost results may be determined in the currency specified by the user (step 405) and simultaneously according to an original currency (step 406). The original currency may be, for example, the currency native to the country specified by the country code. Timing rules 110′ may be applied to determine dates for each stage in prosecution of the patents in a patent family or portfolio (step 407). These dates may be used for reporting and/or further analysis.

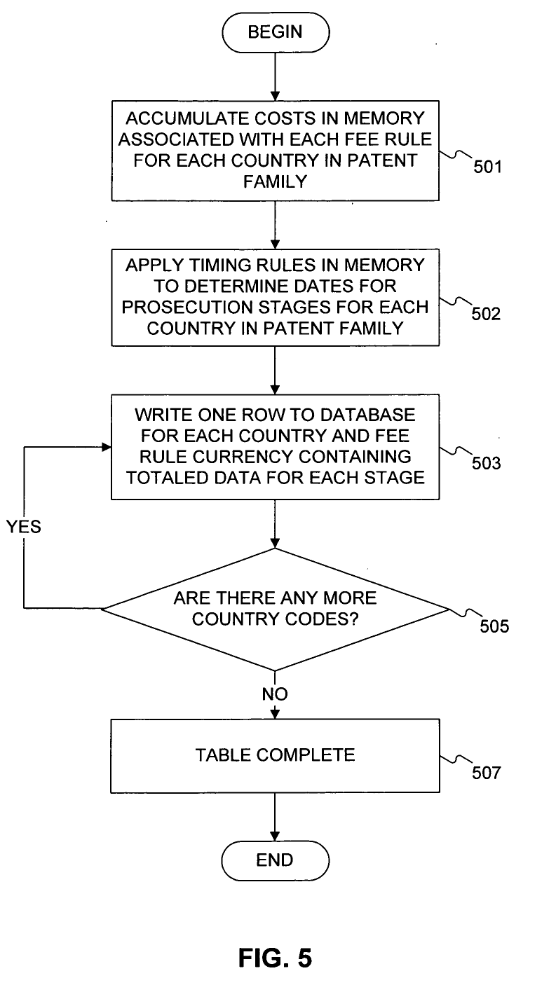

FIG. 5 illustrates an exemplary process for storing cost results, consistent with embodiments of the present invention. PCA 100 may store cost results 111, for example, in database 105 or memory 101. Cost results 111 may be stored according to patent, patent family or patent portfolio. To perform the storing in certain embodiments, cost results 111 may be calculated for all countries in a single patent family. The costs associated with each fee rule 109′ for each country may be accumulated in memory 101 as they are determined (step 501). Once the cost results relating to all fee rules 109′ for every country in a patent family are accumulated in memory 101, timing rules 110′ may be used to calculate prosecution stage dates for every country for every stage in the patent family (step 502). Once cost results and date results for every country in the patent family are accumulated in memory 101, PCA 100 may write one row containing the total cost and date results per stage to a table in database 105 for the country code corresponding to the fee rule (step 503) until all cost and date results 111 have been stored in memory 101 (step 505). Once the cost and date results 111 for all country codes have been stored, the table of cost and date results is complete (step 507). In certain embodiments, cost and date results 111 may be stored in multiple tables. For example, one table may be created containing cost and date results 111 for stages up to grant and a second table may be created containing cost and date results 111 for post-grant costs, such as maintenance fees or annuities.

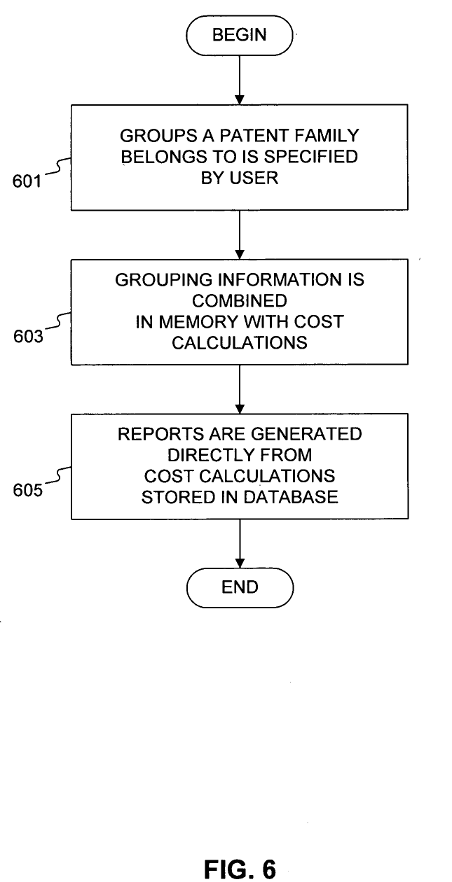

FIG. 6 illustrates an exemplary process for storing grouping information, consistent with embodiments of the present invention. PCA 100 may prompt a user to assign a patent or patent family to a group or groups (step 601). Groups may be based upon, for example, technology type, company division, manager, business unit, product, etc. The grouping information may be combined in memory 101 with the associated cost results 111 (step 603). For example cost results 111 for each patent or family in a group may be flagged or grouped. Once grouping information is received, reports and analyses may be generated directly from cost results 111 based on a group or groups (step 605). A new group can be created at any time. Once a new group is associated with patents or patent families, new analyses and reports may be generated based upon the new group without detailed reprocessing of portfolio costs.

In certain embodiments, once PCA 100 has received patent family data 113, determined cost results 111, received grouping data, etc., then robust and flexible reports and analysis can be produced based on the data. In certain embodiments, reports and analysis are produced based only on stored cost results so that no additional cost calculations are necessary during analysis and/or reporting.

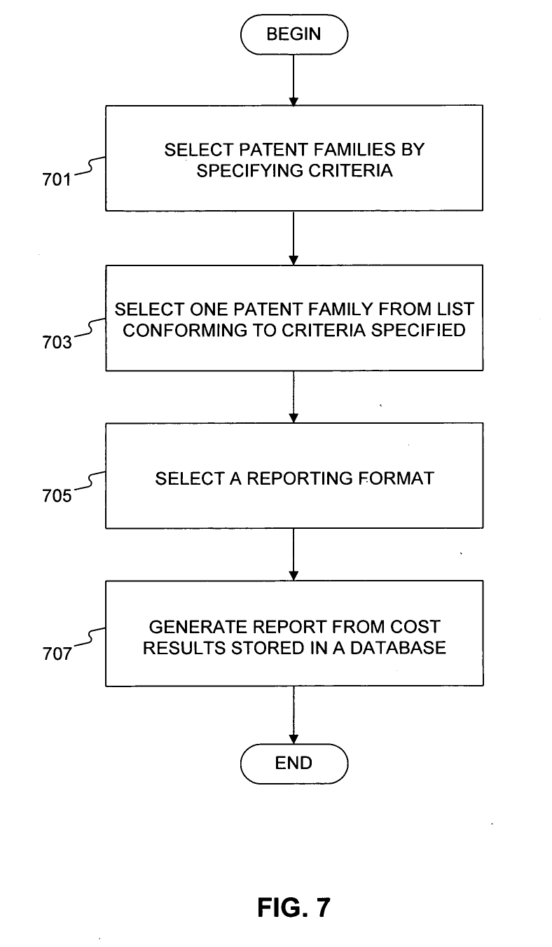

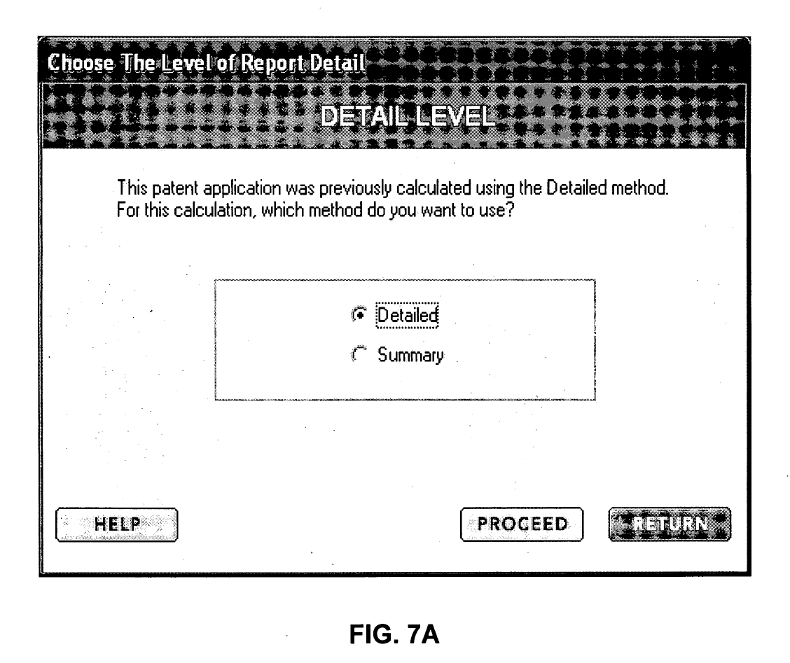

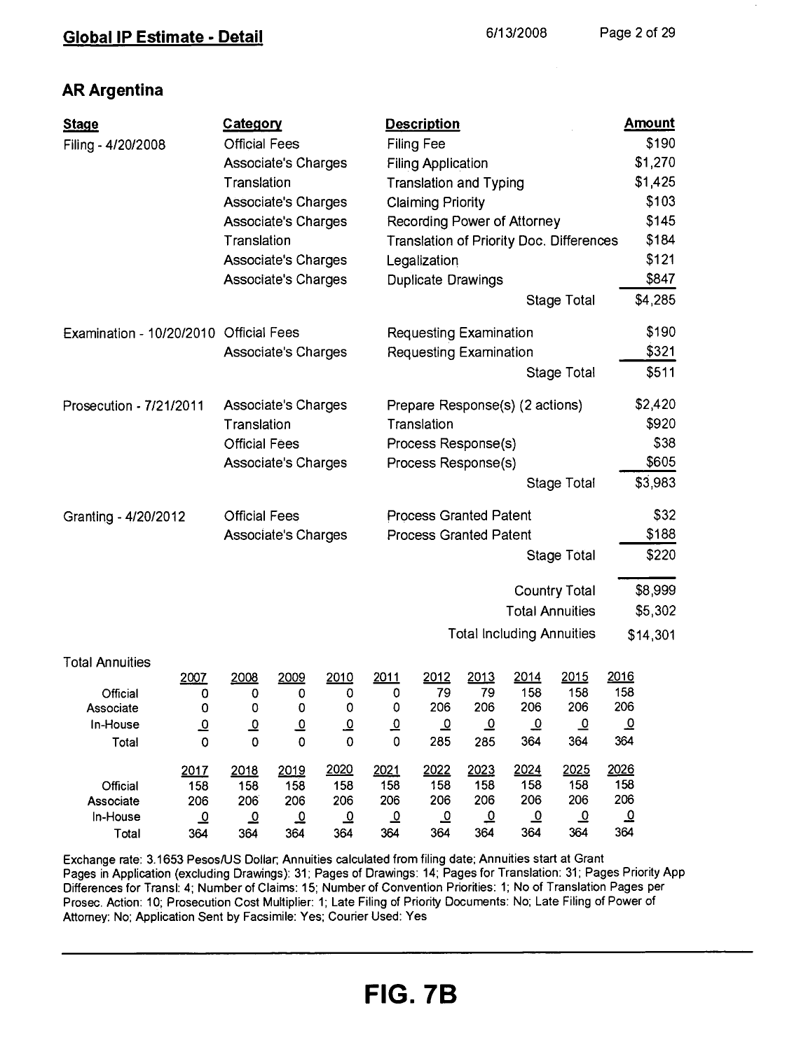

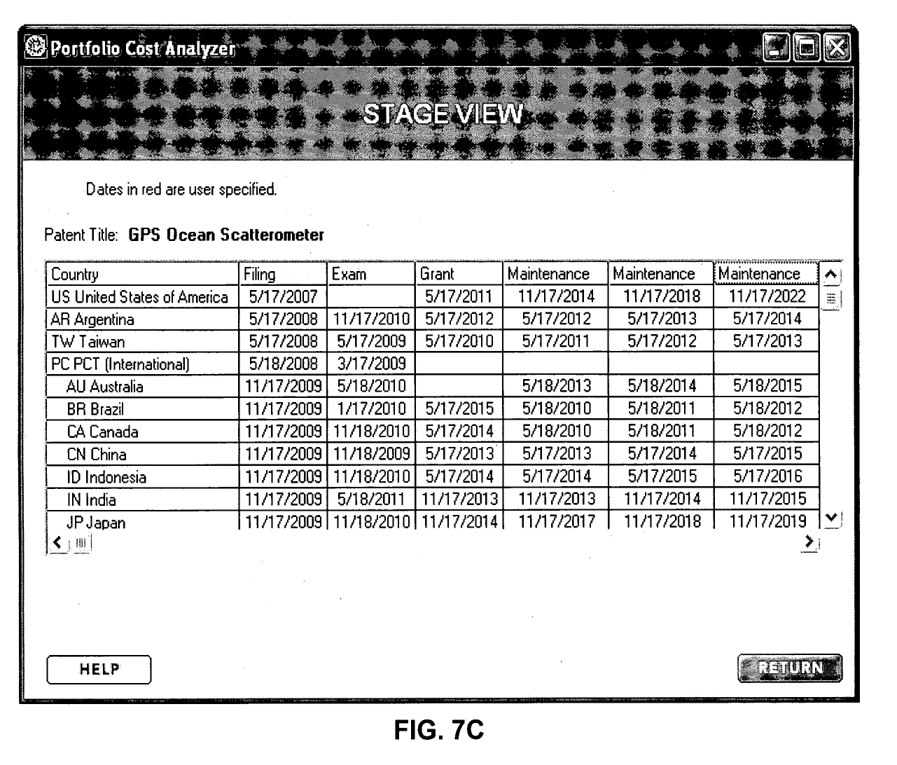

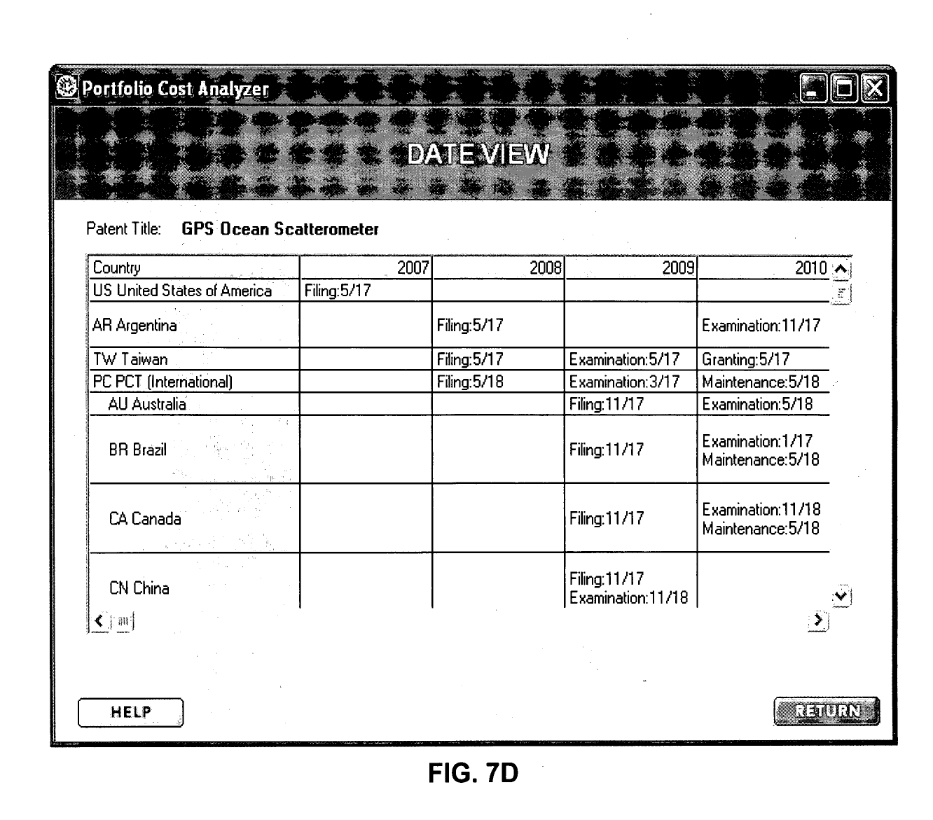

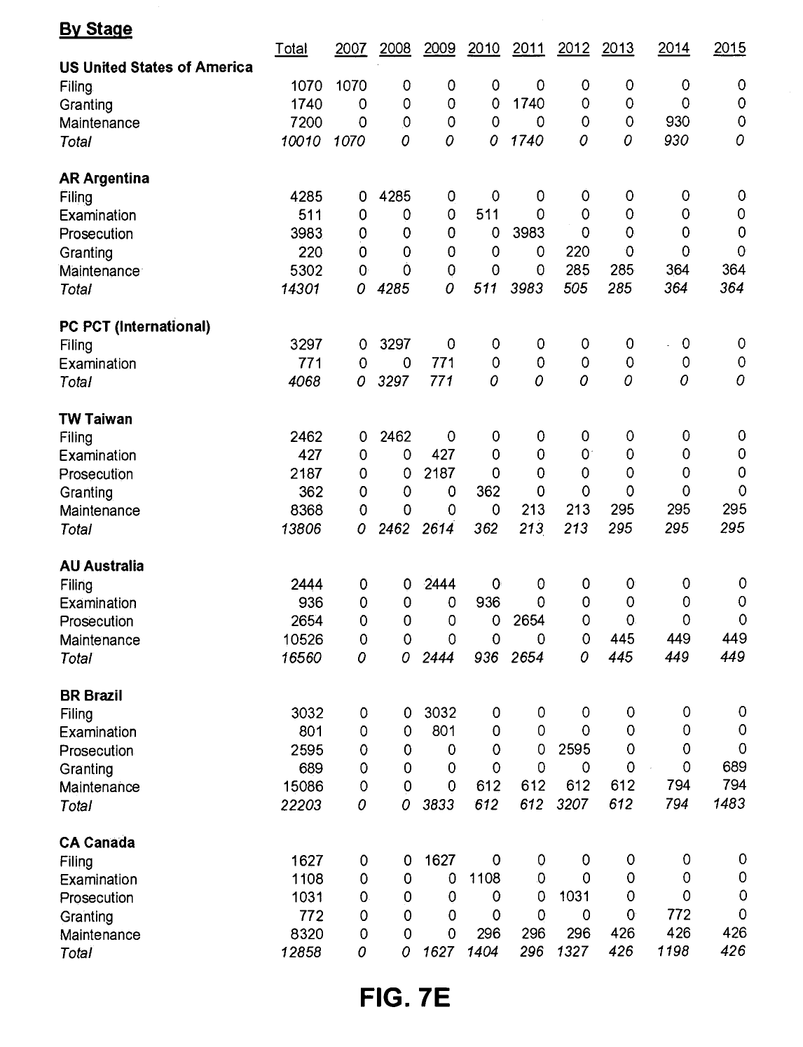

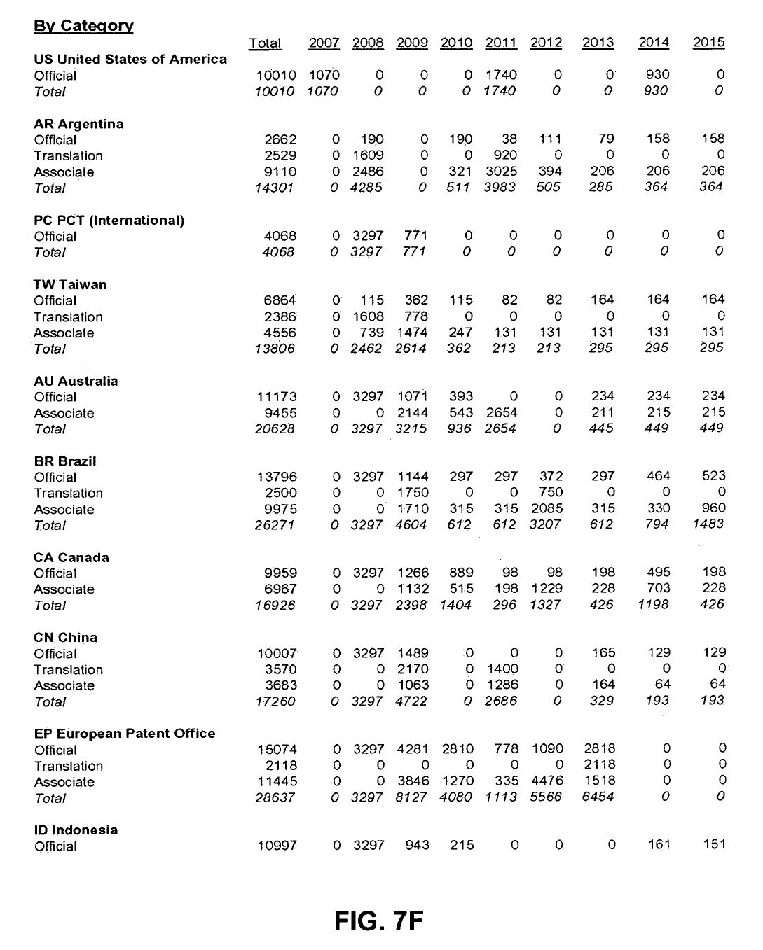

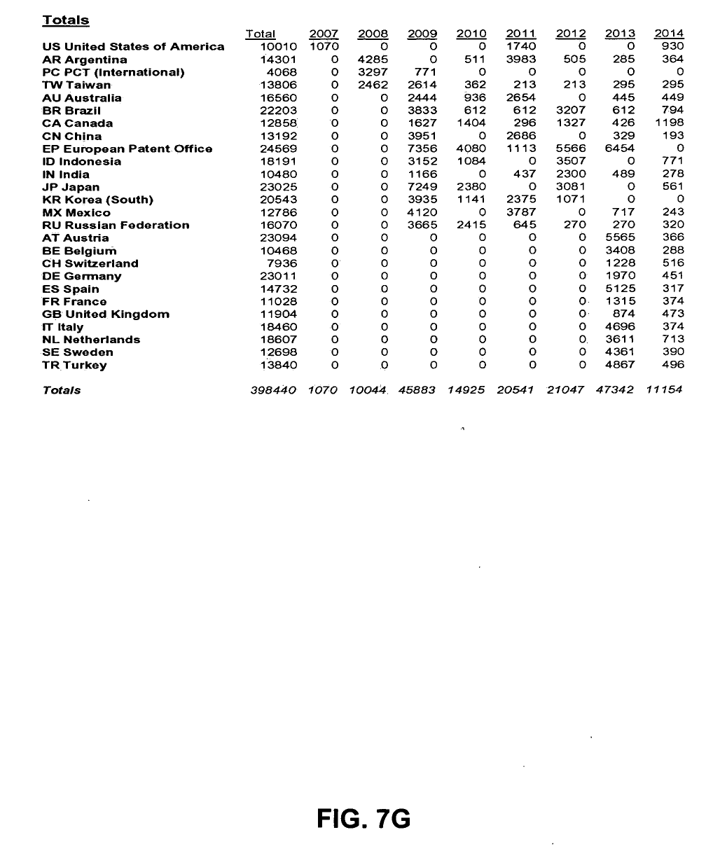

FIG. 7 illustrates an exemplary process for producing reports, consistent with embodiments of the present invention. For example, PCA 100 may provide reporting functionality via reporting module 107. Reporting module 107 may prompt a user to specify patent family selection criteria, e.g., to narrow down the selection of patent families for reporting (step 701). For example, reporting module 107 may enable the user to search for the title of a patent or patent family, an ID number, a group criteria, a specific batch, etc. Once a patent family has been chosen (step 703), a report format may be selected (step 705). The report format may be, for example, a Stage View, Date View, or Cost Details report based on cost results 111. The appropriate cost results 111 may be retrieved from database 105 and the report(s) may be generated from the cost results 111 (step 707) and presented to the user in the selected format (step 709).

FIG. 7A illustrates an exemplary user screen for choosing a reporting format, consistent with embodiments of the present invention. For example, reporting module 107 may give options for different views of the patent family, or different report formats using cost results 111. A detailed report may display each line item of the costs for each application according to its stage and country. In certain embodiments, cost results 111 have been previously determined by cost estimator 103 and stored in database 105. This enables PCA 100 to produce reports and analysis quickly for multiple families. Because of the speed and ease provided by reporting module 107, a user of PCA 100 may request analysis in several different formats, e.g., detailed, by stage, by date, etc. in order to more fully understand future costs associated with a patent family or portfolio.

FIG. 7B illustrates an exemplary detailed report, consistent with embodiments of the present invention. A detailed report may include the stage, stage date, cost category, description, and amount for each line item in a cost estimate for an application in each country. The detailed report may include a stage total for all of the costs in each stage and a country total for all of the costs in each country. The detailed report may further include projected annuities and a total including annuities. Still further, the detailed report may present a summary of costs grouped by year. In addition to a detailed report for each application or country, summary reports may be generated by reporting module 107. A summary report may be formatted, for example, in stage view or date view.

FIG. 7C is an exemplary stage view summary report consistent with embodiments of the present invention. A summary report may summarize the detailed cost, for example, by country or year. A stage view summary report may organize cost and date results 111 according to filing order, such as priority application first, national applications, international or regional applications, and national stage applications based on an international or regional application. In the example of FIG. 7C, the original US application is listed first, followed by national applications in Argentina and Taiwan. Next is a PCT application, followed by national stage applications based on the PCT application. The prosecution stages for each application, such as filing, examination, grant, and maintenance, may also be listed in the stage view summary report, grouped according to prosecution phase. Consistent with certain embodiments, a stage view analysis enables a user of PCA 100 to view the progress of each patent in a patent family through the prosecution stages in a single display screen to facilitate analysis of how the entire patent family will progress over time.

Formatting, such as indentations, spacing, and text color, may be used in reports produced by reporting module 107 to convey additional analysis information. For example, the stage view summary report of FIG. 7C includes a PCT (International) application, followed by several national stage applications (e.g., Australia, Brazil, Canada, China, etc.). The stage view summary report displays the national stage applications indented under the PCT application to convey the relationship between these national stage applications and the PCT applications they are based on. The stage view summary report also displays some dates in red font to indicate that the dates were specified by the user, rather than being determined by PCA 100. A skilled artisan will appreciate that other formatting and display techniques may be used to convey analysis results consistent with the present invention.

FIG. 7D is an exemplary date view summary report consistent with embodiments of the present invention. The date view report may organize the applications according to filing, as in the stage view report, but the date view report may present forecast prosecution stages dates organized by date. In the example of FIG. 7D, future prosecution dates are listed by year, e.g., 2007, 2008, 2009, etc. Consistent with certain embodiments, a date view analysis enables a user of PCA 100 to view each year's activity within a patent family in a single display screen to facilitate analysis of which years will contain much activity in the patent family and which individual patents will be involved.

Reporting module 107 may display data related to a patent family in many other ways to convey analysis to the user. FIG. 7E is a sample summary report of costs by stage. This report may list each patent in a family by country. For example, FIG. 7E displays a family including patent applications in the US, Argentina, PCT (International), Taiwan, Australia, Brazil, and Canada. When a user requests a summary report of costs by stage for this family, reporting module 107 retrieves cost results 111, as determined by cost estimator 103 and stored in database 111, and groups the cost data for each application in the family according to prosecution stage (e.g., filing, examination, prosecution, appeal, granting, maintenance, reexamination), then displays the grouped cost data according to year. The summary report of FIG. 7E also displays a total of future costs for each patent in the family by prosecution stage and overall.

FIG. 7F is a sample summary report of costs by category. This report may list each patent in a family by country. For example, FIG. 7F displays a family including patent applications in the US, Argentina, PCT (International), Taiwan, Australia, Brazil, Canada, China, European Patent Office, and Indonesia. When a user requests a summary report of costs by category for this family, reporting module 107 retrieves cost results 111, as determined by cost estimator 103 and stored in database 111, and groups the cost data for each application in the family according to cost category (e.g., official fees, translation fees, and associate fees), then displays the grouped cost data according to year. The summary report of FIG. 7F also displays a total of future costs for each patent in the family by cost category and overall.

FIG. 7G is a sample summary report of total costs for a patent family or portfolio. This report may list each patent in a family or portfolio by country. For example, FIG. 7G displays a portfolio of applications filed in 26 various countries and international patent offices. When a user requests a summary report of costs by category for this family, reporting module 107 retrieves cost results 111, as determined by cost estimator 103 and stored in database 111, and groups and totals the cost data for each application in the family according to country, then displays the grouped cost data according to year. The summary report of FIG. 7G also displays a total of future costs for each patent in the family by country and overall. In this way, PCA 100 may enable a user to analyze the future costs of pursuing global patent protection for a family or portfolio, as well as the costs for each individual country. Although various reports and examples may describe patent families or patent portfolios, one skilled in the art will recognize that methods and systems consistent with the present invention may be implemented for trademark families, trademark portfolios, portfolios containing different types of intellectual property assets, etc.

In addition to reporting functionality provided by reporting module 107, PCA 100 may enable users to perform flexible, customized analysis of a patent family, patent portfolio, etc. In certain embodiments, PCA 100 performs analysis based on cost results 111 that have been previously determined by cost estimator 103 and stored in database 105.

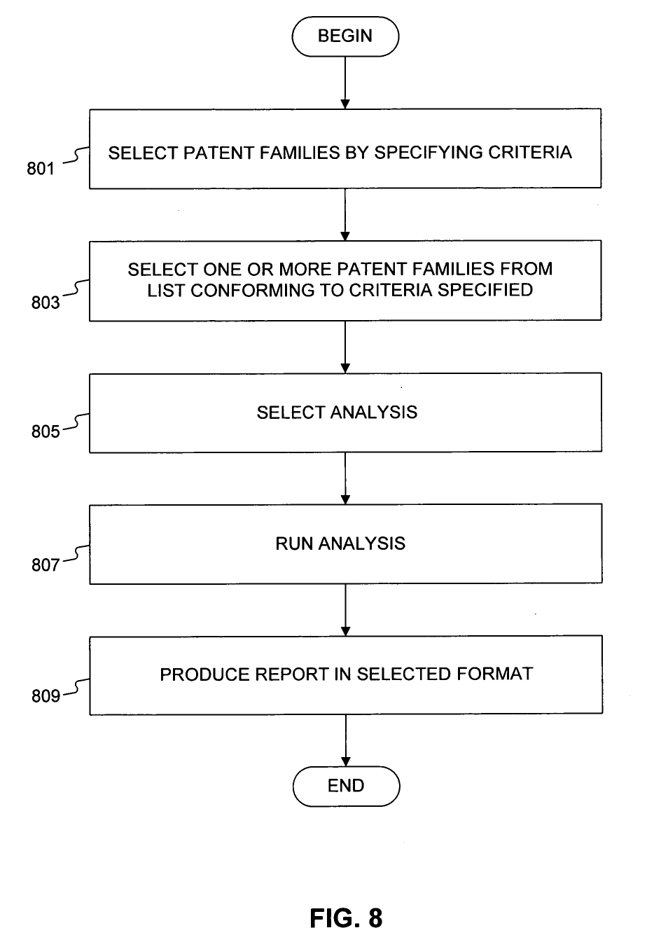

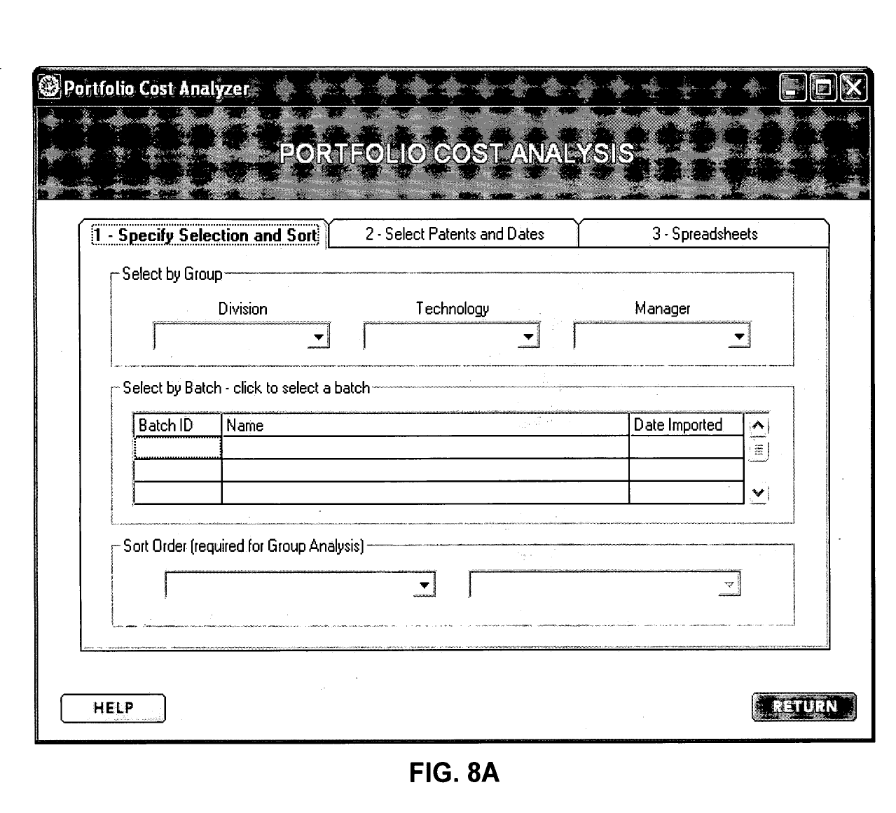

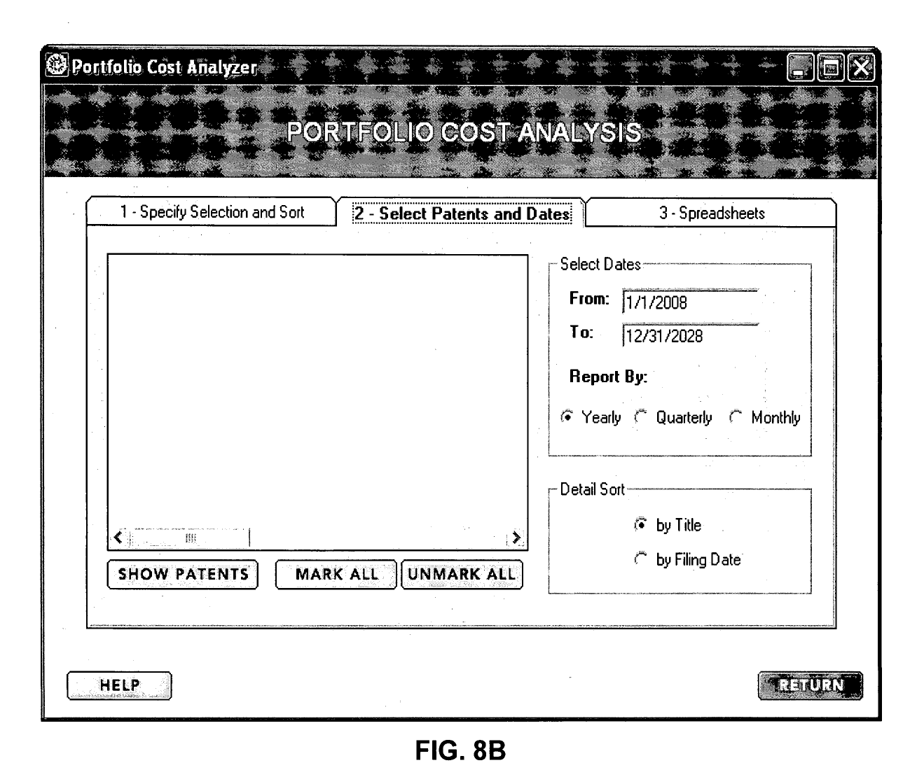

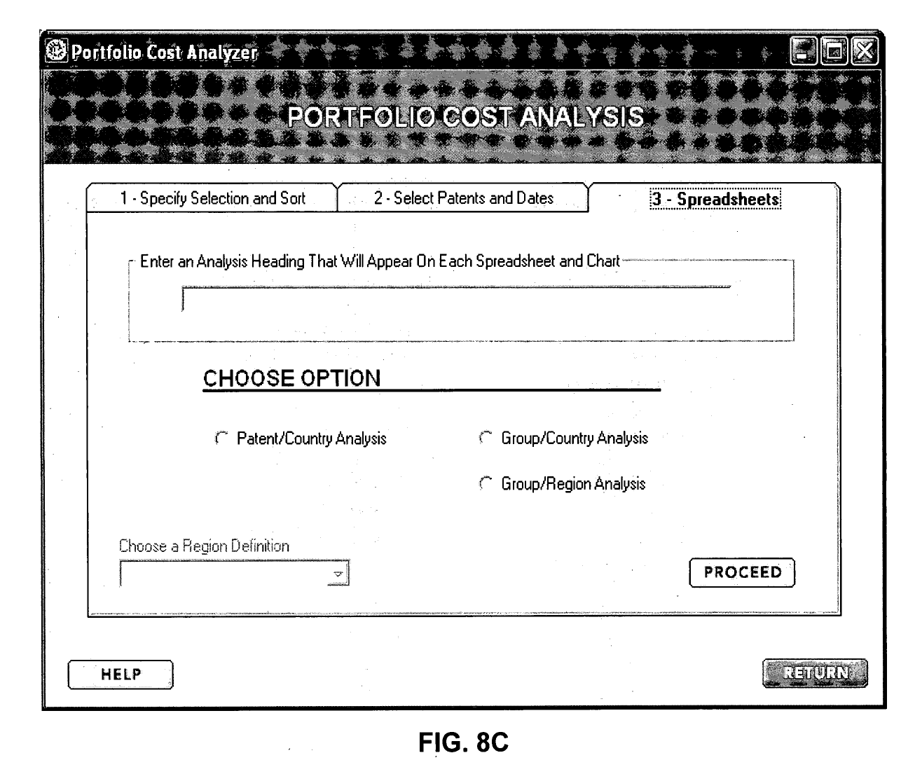

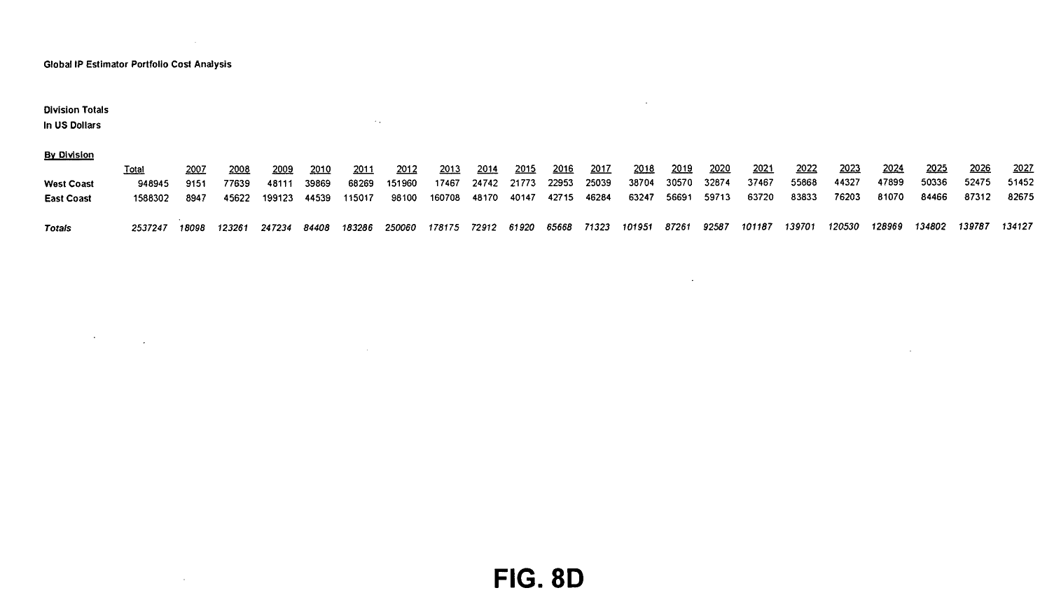

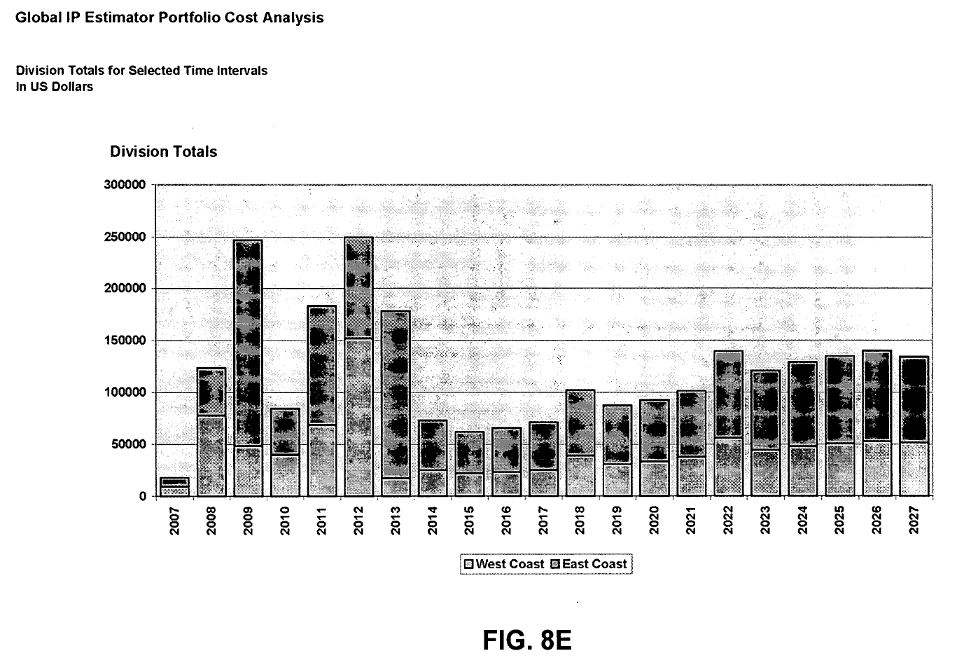

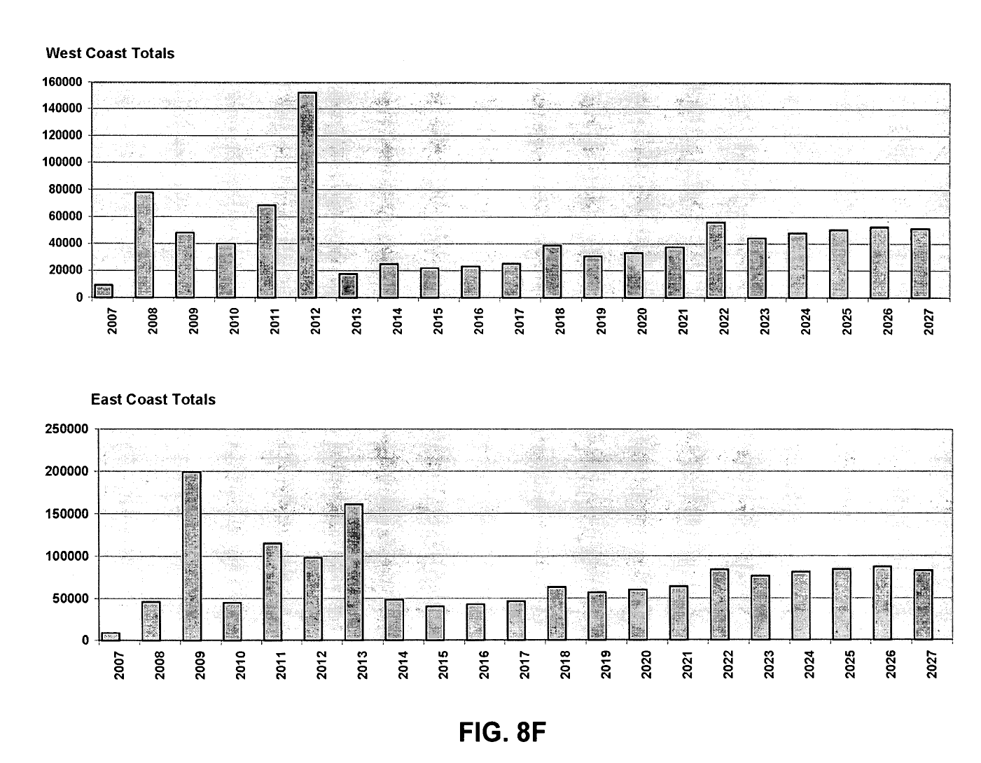

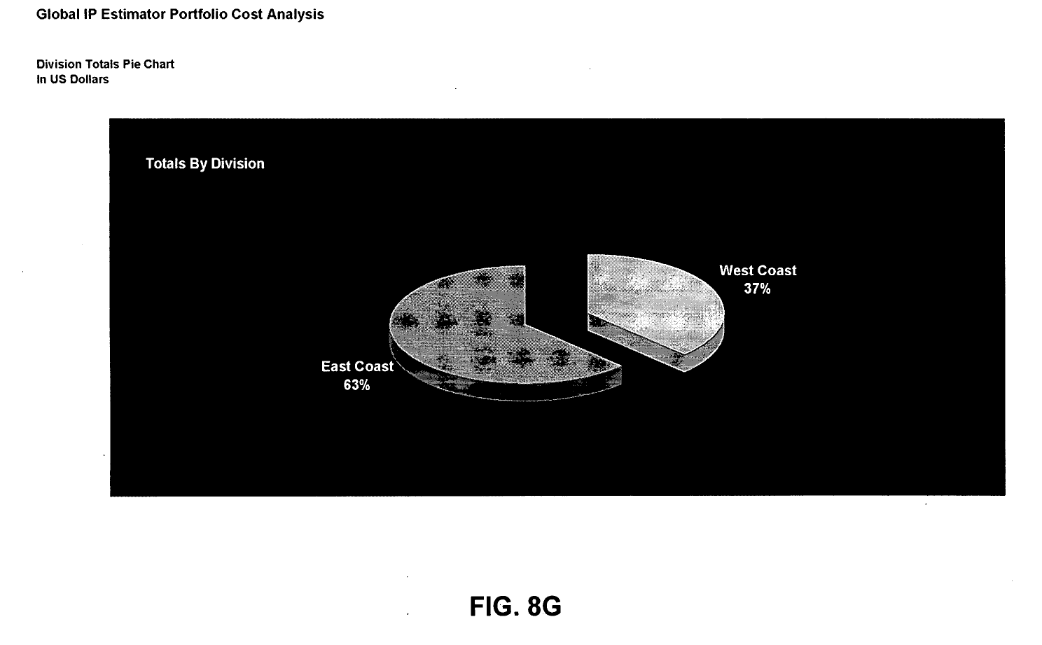

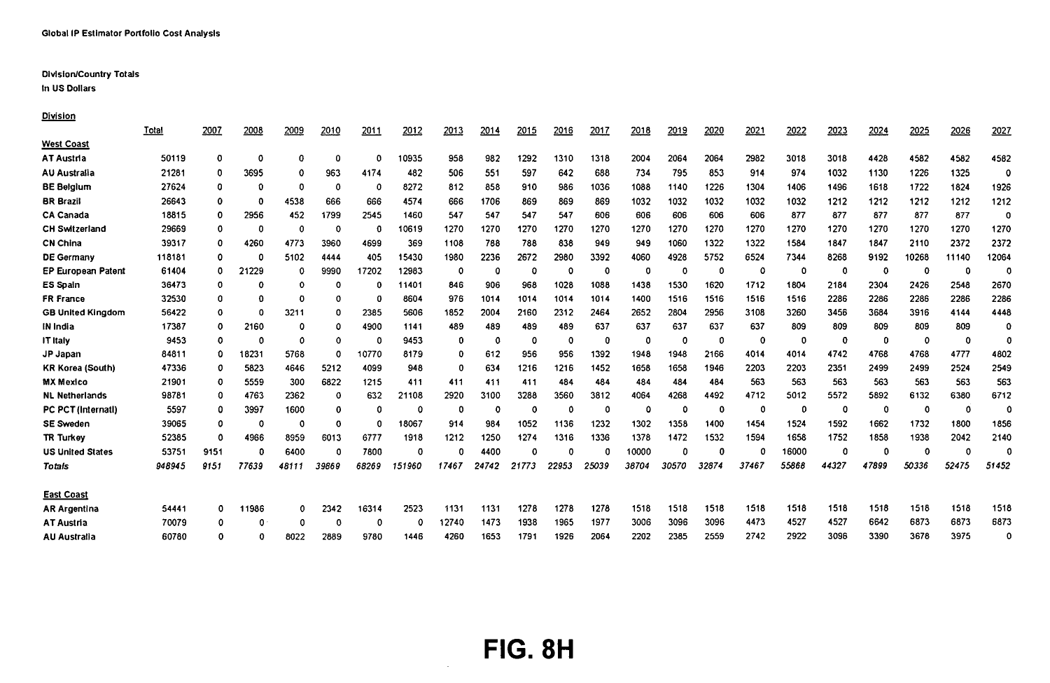

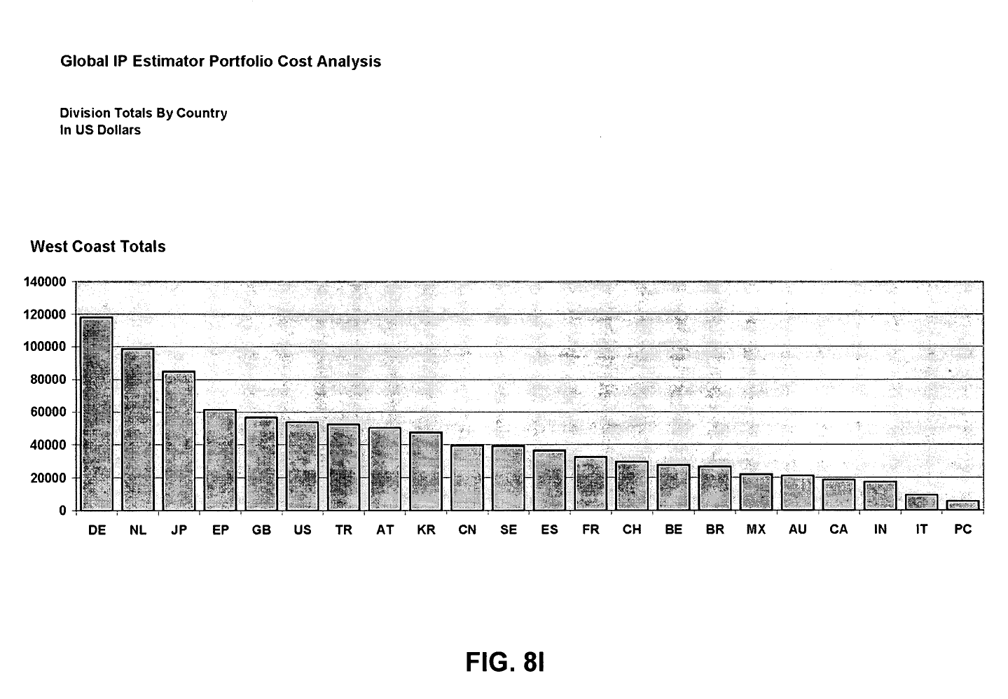

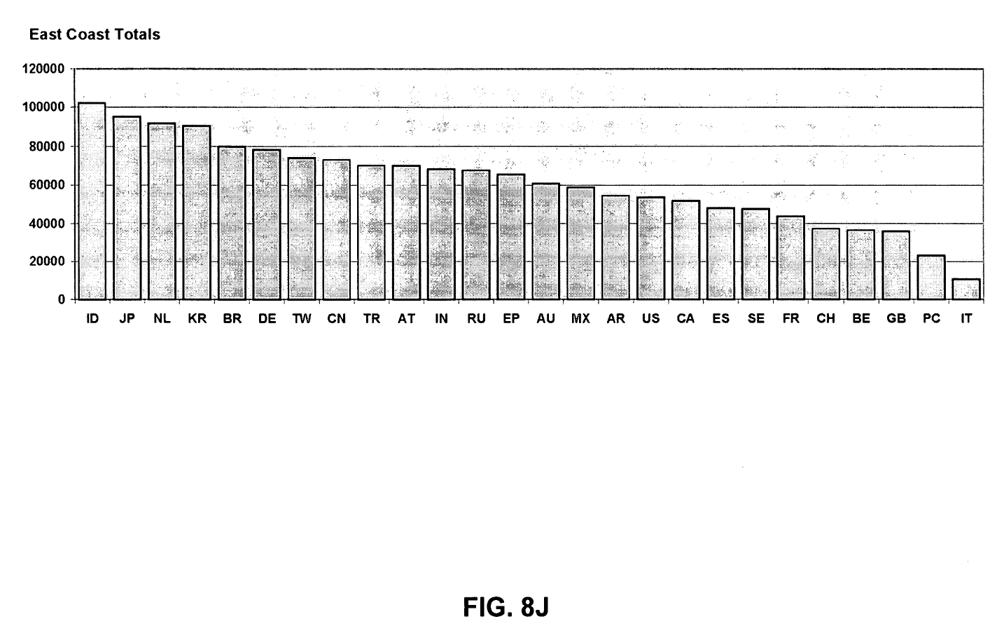

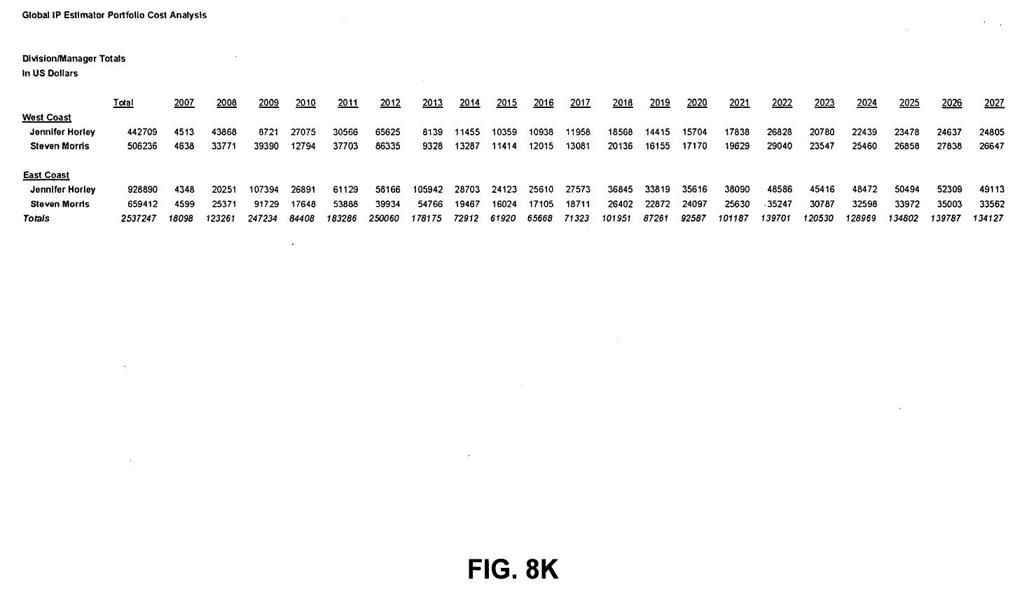

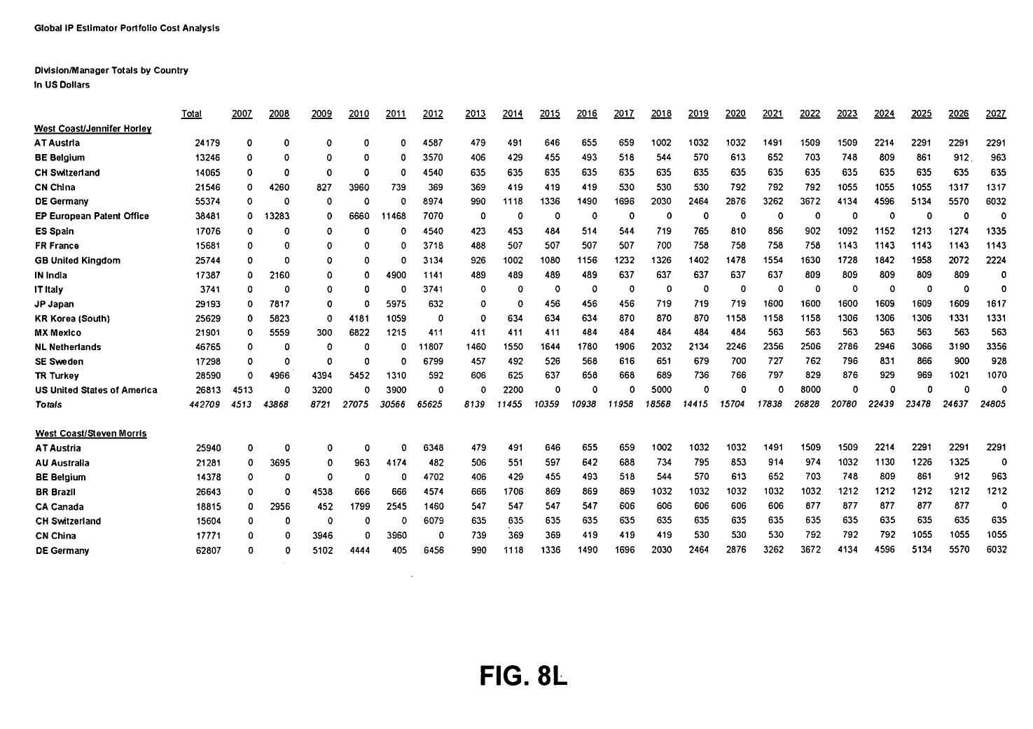

FIG. 8 illustrates an exemplary process for performing analysis, consistent with embodiments of the present invention. PCA 100 may prompt a user to specify criteria for analysis, e.g., to select a set of patent families or portfolios for analysis (step 801). The criteria may, for example, batch file, group, technology unit, business unit, managing attorney, etc. Next, PCA 100 may present a list of patent families meeting the selected criteria to enable the user to select some or all of the patent families for analysis (step 803). An analysis report format may then be selected (step 805). Analysis report formats include, for example, patent/country, group/country, group/region, and portfolio value.

A patent/country analysis format may analyze cost results 111 by individual patent family and country. Any number of patents may be selected for the analysis. The analysis timeframe may be, for example, yearly, quarterly, or monthly. The patent/country analysis reports may include, for example, totals for each patent, period, and country; totals for each country and period across all selected patents; and/or totals for each country accumulated over all patents and periods, displayed in a bar chart.

Finally, PCA 100 performs the analysis based on the selected criteria and families (step 807), and an analysis report is produced according to the selected report format (step 809). In certain embodiments, different analysis reports may be generated for a patent family or portfolio without the need for reprocessing fee rules 109 or patent family data 113 by using the already determined cost results 111.

FIG. 8A illustrates an exemplary user screen for selecting patents, patent families, and patent portfolios to analyze, consistent with embodiments of the present invention. PCA 100 may display this flexible user screen to present criteria to the user such as, division, technology, and manager. Each criteria may include a drop-down list of options for the user to select. For example, the Division criteria may include a drop-down list of options including the different divisions corresponding to patent family data 113. The user screen of FIG. 8A may also include a list of batches of patents, including batch ID, name, and import date. The user screen may further include options for the user to select a sort order, e.g., the sort order of the groupings for the resulting analysis report. The sort order may be, for example, by manager first, and within manager by division, by patent, by country, by category, etc. Once the user has input analysis criteria, such as division, technology, manager, batch ID, etc. and/or a sort order, PCA 100 may enable the user to select a subset of the patents meeting the criteria.

FIG. 8B illustrates an exemplary user screen for selecting some or all patent families meeting specified criteria, consistent with embodiments of the present invention. For example, PCA 100 could receive criteria from the user, retrieve patent family data 113 and/or cost results 111 that match the criteria, and display the patents to the user via the user screen shown in FIG. 8B. PCA 100 may provide tools to the user for selecting patents from the list. For example, the user could select one or more patents from the list, e.g., by clicking a checkbox or otherwise selecting each patent. The user could also be offered the option to select or mark all of the patents on the list or deselect or unmark all of the patents on the list. The user may also have the option to select a date range and report order, such as yearly, quarterly, or monthly. Further detail sort options may also be presented, such as sorting by title, filing date, or other information.

FIG. 8C illustrates another exemplary user screen for portfolio cost analysis, consistent with embodiments of the present invention. PCA 100 may enable the user to enter or select a heading for the analysis reports and choose among different types of analysis that may be done for each family or portfolio, such as patent/country, group/country, group/region, etc. The group/country analysis format may analyze by patent grouping and country. One or more patent groups may be identified for analysis. In certain embodiments, the user may identify a major group and a sub-group, and the selected patents may then analyzed by country for the group and sub-group. The timeframe may be, for example, yearly, quarterly or monthly.

For example, if a user requests yearly analysis, designates Division as the major group, and designates Manager as the sub-group, then the analysis may contain, for example, cost data and/or totals for each Division for each year; cost data and/or totals for each Division for each year displayed in a bar chart; cost data and/or totals for each Division over all years displayed in a pie chart; cost data and/or totals for each Division for each year broken down by country; cost data and/or totals for each Division for each year broken down by country displayed in a bar chart; cost data and/or totals for each Division and Manager combination for each year; and cost data and/or totals for each Division and Manager combination for each year broken down by country. In addition to cost data, other application data, such as number of applications, number of patents, number of claims, filing countries, trends, etc. may also be analyzed for the selected Division or Manager.

The group/region analysis format may analyze by patent grouping and region. Regions may be, for example, groupings of countries identified by the user. Initial regional definitions may be provided containing the major geographical regions. For example, the region “Europe” may contain all the countries in Europe, or all the countries corresponding to the European Patent Office. Alternatively, regions may correspond to the business organization of a global company. PCA 100 may present multiple region definitions to the user for selecting for analysis and reporting.

A portfolio value analysis format may analyze any number of patents by country. The timeframe may be, for example, yearly, quarterly or monthly. Concepts used for this analysis may include: a user-defined basis of value, such as the projected real gross domestic product (“GDP”) by country; sales levels assigned to patents reflecting relative sales potential; time factors such as the value decline level; years to production; etc. In certain embodiments, analysis reports may cover several patents, all with similar basic data and countries, but with different sales levels, decline levels, and years to production. The reports may include patent costs for each patent by year in each country, a patent value for each patent by year in each country, and a patent value to cost ratio. The patent value may be the product of the real GDP for the year in that country, the sales factor, and the decline factor. The patent value to cost ratio may be calculated for each patent for each year for each country.

FIGS. 8D-8L depict sample analysis reports for a patent portfolio, consistent with embodiments of the present invention. In certain embodiments, analysis module 108 may analyze cost and timing data for up to two patent groups: one major group and one sub-group. The selected patents are then analyzed by country for the major group and sub-group. In certain embodiments, the user may select to have analysis performed on a yearly, quarterly, or monthly basis. For example, FIG. 8D depicts total predicted costs for two divisions, West Coast and East Coast, by year. FIG. 8E depicts total predicted yearly costs for these two divisions using a bar graph display. FIG. 8F depicts total predicted costs for each division per year. FIG. 8G depicts total predicted yearly costs for these two divisions using a pie chart display. FIG. 8H depicts total costs per year by individual country. These country totals are grouped according to division. The country total costs may also be totaled per division. FIGS. 8I and 8J depict total costs per year by individual country using a bar graph display for each division. FIG. 8K depicts total costs by year per manager in each division. FIG. 8L depicts total costs by year per manager in each division, further broken down by individual country.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing costs for a portfolio of intellectual property assets, comprising:
receiving data about a plurality of intellectual property assets in the portfolio;
providing fee rules for countries in the plurality of intellectual property assets, each fee rule including at least one of a country code, cost type, stage code, application information item, and currency code;
applying the fee rules to determine cost data for the plurality of intellectual property assets;
enabling a user to select a subset of the plurality of intellectual property assets;
receiving an analysis selection from the user specifying an analysis based on all or part of the plurality of intellectual property assets; and
presenting the determined cost data for the subset of intellectual property assets to the user according to the analysis selection.

2. The method of claim 1, wherein applying the fee rules further comprises:
creating a fee rule file in memory from a database of fee rules;
creating an index of the fee rule file by country code in the memory; and
rapidly accessing the fee rules by accessing the index in the memory.

3. The method of claim 1, wherein applying the fee rules further comprises:
determining an individual cost using each fee rule for each asset in the portfolio of intellectual property assets; and
storing the individual costs by asset, country code, cost type, stage code, and currency code.

4. The method of claim 1, wherein applying the fee rules further comprises:
determining the cost data in an original currency specified by the fee rules;
receiving a user-specified currency selection from the user;
determining user-specified cost data in the user-specified currency; and
storing the cost data in the original currency together with the user-specified cost data.

5. The method of claim 1, further comprising:
storing the determined cost data in a summarized form by totaling amounts for each asset, country code, cost type and stage code that share a fee rule currency.

6. The method of claim 1, further comprising:
receiving an updated analysis selection from the user based on at least a subset of the intellectual property assets;
analyzing the determined cost data according to the updated analysis selection without reapplying the fee rules by utilizing stored cost data; and
presenting the updated analysis to the user according to the updated analysis selection.

7. The method of claim 1, further comprising:
receiving an updated set of currency exchange rates; and
analyzing the cost data by applying the new exchange rates to stored costs, without reapplying the fee rules.

8. The method of claim 1, wherein enabling the user to select the subset of the plurality of intellectual property assets further comprises:
receiving a set of criteria from the user selecting a group within the plurality of intellectual property assets;
displaying a list of intellectual property assets meeting the criteria; and
receiving a selection from the user of one or more intellectual property assets from the list of intellectual property assets.

9. The method of claim 1, wherein receiving data about the plurality of intellectual property assets further comprises receiving family identification data to identify a family for each of the intellectual property assets.

10. A method for managing costs for a portfolio of intellectual property assets, comprising:
receiving data about the portfolio of intellectual property assets, the data including a family designation for each intellectual property asset in the portfolio;
identifying fee rules corresponding to countries in the plurality of intellectual property assets, each fee rule including at least one of a country code, cost type, stage code, application information item, and currency code;
identifying prosecution stage timing rules corresponding to the countries in the plurality of intellectual property assets, each prosecution stage timing rule including at least one of a country code, stage code, and a time to reach the stage;
applying the fee rules and prosecution stage timing rules to determine cost data and prosecution stage timing dates for each asset in the plurality of intellectual property assets;
enabling a user to select a subset of the plurality of intellectual property assets;
enabling a user to select an analysis; and
presenting the determined cost data and prosecution stage timing data for the subset of intellectual property assets to the user according to the selected analysis.

11. The method of claim 10, wherein applying the fee rules further comprises:
creating a fee rule file in memory from a database of fee rules;
creating an index of the fee rule file by country code in the memory; and
rapidly accessing the fee rules by accessing the index in the memory.

12. The method of claim 10, wherein applying the prosecution stage timing rules further comprises:
creating a prosecution stage rule file in memory from a database of prosecution stage rules;
creating an index of the prosecution stage rule file by country code in the memory; and
rapidly accessing the prosecution stage rules by accessing the index in the memory.

13. The method of claim 10, wherein applying the fee rules further comprises:
determining an individual cost using each fee rule for each asset in the portfolio of intellectual property assets; and
storing the individual costs by asset, country code, cost type, stage code, and currency code.

14. The method of claim 10, wherein applying the prosecution stage timing rules further comprises:
determining individual prosecution stage timing dates using each prosecution stage rule for each asset in the portfolio of intellectual property assets; and
storing the individual prosecution stage timing dates by asset, country code, cost type, and stage code.

15. The method of claim 10, further comprising:
receiving an updated analysis selection from the user based on the subset of the intellectual property assets;
analyzing the determined cost data and prosecution stage timing dates according to the updated analysis selection without reapplying the fee rules or the prosecution stage timing rules by utilizing stored data; and
presenting the updated analysis to the user according to the updated analysis selection.

16. The method of claim 10, wherein the selected analysis specifies an analysis report format including one of a bar chart, a pie chart, a spreadsheet, and an itemized cost and date report.

17. The method of claim 10, wherein the selected analysis specifies an analysis report organized by one of year, quarter, and month.

18. The method of claim 10, wherein the selected analysis specifies a Stage View report format including a patent family's actual and predicted prosecution stages with the prosecution stage timing data depicted as columns and countries depicted in rows sorted and indented by application type and by country name within application type.

19. The method of claim 10, wherein the selected analysis specifies a Date View report format including a patent family's actual and predicted prosecution stages with future years depicted as columns and countries depicted as rows sorted and indented by application type.

20. The method of claim 10, wherein the selected analysis specifies an analysis report format including overall prosecution stage costs displayed according to the prosecution stage timing data for each intellectual property asset in each country.

21. The method of claim 10, wherein receiving data about intellectual property assets further comprises:
enabling the user to import data by batch.

22. The method of claim 10, further comprising:
receiving grouping data from the user, the grouping data specifying one of a business unit, a technology type, and a manager for the intellectual property assets.

23. The method of claim 10, wherein enabling the user to select the subset of the plurality of intellectual property assets further comprises:
receiving selection criteria from the user;
displaying a list of intellectual property families meeting the selection criteria; and
receiving a selection from the user of one or more intellectual property families from the list of intellectual property families.

24. The method of claim 10, wherein presenting further includes:
aggregating the cost data and the prosecution stage date data by group;
grouping the cost data and the prosecution stage data by sub-group within the group; and
displaying the cost data and the prosecution stage data organized by one of group and sub-group.

25. A method for analyzing costs for a patent portfolio including a plurality of patent families, comprising:
receiving patent data about each patent asset in the plurality of patent families, the patent data including a country code and asset attributes;
identifying fee rules for the patent portfolio, each fee rule including a country code, a stage code, and a fee category;
for each patent asset in the patent portfolio:
predicting a date when the asset will enter a prosecution stage based on the corresponding asset attributes, the prosecution stage being one of filing, examination, grant, and maintenance,
selecting fee rules corresponding to the country code of the patent asset and the stage code corresponding to the prosecution stage, and
applying the selected fee rules to the patent data about the patent asset to determine stage costs for the patent asset;
collecting the stage costs for the plurality of patent assets in the patent portfolio to determine overall stage costs for each prosecution stage; and
presenting the overall stage costs for the patent portfolio.

26. The method of claim 25, further comprising:
analyzing the overall stage costs according to prosecution stage.

27. The method of claim 25, further comprising:
analyzing the overall stage costs according to patent family.

28. The method of claim 25, further comprising:
analyzing the overall stage costs according to dates when the patent assets are predicted to enter each prosecution stage.

29. The method of claim 25, further comprising:
presenting a list of the patent families in the patent portfolio;
receiving a selection of a subset of the patent families;
and presenting family stage costs based on the stage costs of the subset of patent families.

30. The method of claim 25, wherein the asset attributes include at least one of: a filing date, a priority date, a number of pages, a number of claims, a technology area, and an asset value over time.

31. The method of claim 25, wherein presenting further comprises:
presenting filing costs, prosecution costs, and maintenance costs for a subset of the patent families for a selected time period together with a comparison to the patent families' values.

32. A computer system for managing costs for a portfolio of intellectual property assets, comprising:
a receiving component configured to receive data about a plurality of intellectual property assets in the portfolio;
a providing component configured to provide fee rules for countries in the plurality of intellectual property assets, each fee rule including at least one of a country code, cost type, stage code, application information item, and currency code;
an applying component configured to apply the fee rules to determine cost data for the plurality of intellectual property assets;
an enabling component configured to enable a user to select a subset of the plurality of intellectual property assets;
a receiving component configured to receive an analysis selection from the user specifying an analysis based on all or part of the plurality of intellectual property assets; and
a presenting component configured to present the determined cost data for the subset of intellectual property assets to the user according to the analysis selection.

33. A system for managing costs for a portfolio of intellectual property assets, comprising:
a receiving component configured to receive data about the portfolio of intellectual property assets, the data including a family designation for each intellectual property asset in the portfolio;
a first identifying component configured to receive identify fee rules corresponding to countries in the plurality of intellectual property assets, each fee rule including at least one of a country code, cost type, stage code, application information item, and currency code;
a second identifying component configured to identify prosecution stage timing rules corresponding to the countries in the plurality of intellectual property assets, each prosecution stage timing rule including at least one of a country code, stage code, and a time to reach the stage;
an applying component configured to apply the fee rules and prosecution stage timing rules to determine cost data and prosecution stage timing dates for each asset in the plurality of intellectual property assets;
a first enabling component configured to enable a user to select a subset of the plurality of intellectual property assets;
a second enabling component configured to enable a user to select an analysis; and
a presenting component configured to present the determined cost data and prosecution stage timing data for the subset of intellectual property assets to the user according to the selected analysis.

34. A system for analyzing costs for a patent portfolio including a plurality of patent families, comprising:
a receiving component configured to receive patent data about each patent asset in the plurality of patent families, the patent data including a country code and asset attributes;
an identifying component configured to identify fee rules for the patent portfolio, each fee rule including a country code, a stage code, and a fee category;
a processor configured to perform, for each patent asset in the patent portfolio:
predicting a date when the asset will enter a prosecution stage based on the corresponding asset attributes, the prosecution stage being one of filing, examination, grant, and maintenance,
selecting fee rules corresponding to the country code of the patent asset and the stage code corresponding to the prosecution stage, and
applying the selected fee rules to the patent data about the patent asset to determine stage costs for the patent asset;
a collecting component configured to collect the stage costs for the plurality of patent assets in the patent portfolio to determine overall stage costs for each prosecution stage; and
a presenting component configured to present the overall stage costs for the patent portfolio.
